(19) United States
(12) Patent Application Publication
(10) Pub. No.: US 2020/0079586 A1
(43) Pub. Date: Mar. 12, 2020

(54) LATCH ASSEMBLY FOR A CONTAINER

(71) Applicants: Derek ASMIS, Sparks, NV (US); Jamie ASMIS, Sparks, NV (US)

(72) Inventors: Derek ASMIS, Sparks, NV (US); Jamie ASMIS, Sparks, NV (US)

(21) Appl. No.: 16/125,630

(22) Filed: Sep. 7, 2018

(51) Int. Cl. B65F 1/16

(52) U.S. Cl. CPC B65F 1/1615; B65F 2210/148

(57) ABSTRACT

The present disclosure provides a latch assembly for a container. The latch assembly includes a mounting member coupled to the container. The container includes a lid operable between an open position and a closed position. A locking member is pivotally mounted to the mounting member. The locking member is operable between a locking position and an unlocking position, corresponding to inclination of the container. In locking position, the locking member engages a panel of the container for locking the lid in the closed position, when the container is in a first inclined position. In unlocking position, the locking member disengages from the panel for unlocking the lid to the open position, when the container is in a second inclined position. The latch assembly controls operation of lid between the open position and the closed position, corresponding to inclination of the container.

### TECHNICAL FIELD

The present disclosure generally relates to a latch assembly for a container and, more particularly relates to, a latch assembly mounted to a lid of a garbage container, adapted to maintain an open position or a closed position of the lid, corresponding to an inclination of the garbage container.

### BACKGROUND

Containers such as but not limited to garbage bins are waste material storage receptacles, typically used for temporarily storing the waste material prior to its disposal. The garbage bins are equipped with lids, to contain the waste material and also to avoid spillage during use or in the event of transportation. The lids also ensure that pungent smell emanating from the stored waste material is trapped within the garbage bin, for ensuring a cleaner and sterile waste material management.

Typically, the lid may be snap-fitted onto the garbage bin, for sterile waste management. However, upon prolonged storage of the waste material in the garbage bin, contact surfaces of the lid and the garbage bin may flake, which may result in a snug fit between the lid and the garbage bin. Consequently, a vendor may be required to exert a force on the lid, for unlocking and accessing the waste materials, during which, the waste materials may spill out due to the force exerted by the vendor. Additionally, if the garbage bins were made of cheaper and low-quality materials, the force applied by the vendor may structurally damage the garbage bin, which may render it unusable.

To overcome such limitations in snap-fit type lids as mentioned above, hinged lids are mounted onto the garbage bins, which are pivotally operable between an open position and a closed position. The hinged lids are typically made of light-weight construction materials, so that the vendor may effortlessly operate the lid between the open position and the closed position. This configuration ensures that the vendor operates the hinged lid between the open position and the closed position, as and when required without the need for exerting excessive force. Although the hinged lids mitigate the limitations associated with snap-fit type lids, the hinged lids being made of light-weight construction materials may effortlessly be operated to the open position for example, due to a wind blowing on the hinged lid. In other words, the hinged lid, being light may be operated to the open position even due to the wind blowing over the hinged lid, which is undesirable.

Such effortless actuation of the hinged-lid may be prevented by the provision of a coupling device. The coupling device may act as a locking member to the hinged-lid so that the hinged lid can be actuated to the open position, only when desired. However, mounting of the coupling device may hinder the repeatable or periodic use of the garbage bin, as the coupling device may need to be unlatched at the time of use of the garbage bin, which is cumbersome and undesirable. This may also affect the waste material management, as a substantial time may be required for unlatching the coupling device and then accessing the waste material from the garbage bin. Moreover, the coupling device may require significant effort for unlatching, which may structurally damage the garbage bin, which is again undesirable.

In light of the foregoing discussion, a latch assembly for a container, particularly the garbage container is required to overcome the limitations stated above.

The information disclosed in this background of the disclosure section is only for enhancement of understanding of the general background of the invention and should not be taken as an acknowledgment that this information forms the prior art already known to a person skilled in the art.

### SUMMARY

Various embodiments of the present disclosure provide a latch assembly for a container.

The present disclosure provides a latch assembly for a container. The latch assembly includes a mounting member coupled to the container, the container including a lid operable between an open position and a closed position. A locking member is pivotally mounted to the mounting member. The locking member is operable between a locking position and an unlocking position, corresponding to an inclination of the container. In the locking position, the locking member engages a panel of the container for locking the lid in the closed position, when the container is in a first inclined position. In the unlocking position, the locking member disengages from the panel for unlocking the lid to the open position, when the container is in a second inclined position.

In an embodiment, the at least one mounting member is fastened to a lid of the container.

In an embodiment, the first inclined position is a vertical position of the container about a horizontal axis.

In an embodiment, the second inclined position is a tilted position of the container towards an opening of the lid, by an angle (β) ranging from about 0 degrees to about 90 degrees, about the horizontal axis.

In an embodiment, the at least one locking member engages with a lip of the panel, for locking the lid in the closed position.

In an embodiment, the at least one locking member includes a first end fastened to the at least one mounting member via one or more struts and a second end including a grommet adapted to engage with the panel for locking the lid in the closed position.

In an embodiment, a gap persists between the second end of the at least one locking member and the lip, so that the at least one locking member may disengage from the lip when the container is in the second inclined position.

In an embodiment, each of the at least one locking member comprises at least one slot, wherein each of the at least one slot is selectively aligned with at least one aperture on the one or more struts, to facilitate adjustment of the gap between the lip of the panel and the second end of the at least one locking member.

In an embodiment, the at least one locking member is adjustable, corresponding to the dimensions of the panel.

In an embodiment, the at least one mounting member is fastened to a barrel of the container.

In an embodiment, at least one bracket having one end is secured to each of the at least one mounting member and another end mounted to the lid of the container, for supporting the at least one mounting member on the lid.

In another embodiment, the present disclosure discloses a container. The container includes a casing for storing at least one object, a lid pivotally mounted on the casing for containing at least one object. The lid is operable between an open position and a closed position and the latch assembly. The latch assembly includes at least one mounting member coupled to the lid and at least one locking member pivotally mounted to the at least one mounting member. The at least one locking member is operable between a locking position and an unlocking position, corresponding to an inclination of the casing. In the locking position, the at least one locking member engages a panel of the casing for locking the lid in the closed position when the casing is in a first inclined position. In the unlocking position, the at least one locking member disengages from the panel for unlocking the lid to the open position, when the casing is in a second inclined position.

In another embodiment, the present disclosure discloses a garbage container. The garbage container includes a casing for storing garbage and a lid pivotally mounted on the casing for containing the garbage. The lid is operable between an open position and a closed position. A hinge plate is mounted on the lid and includes a first arm and a second arm. The hinge plate mounted on the lid via the first arm and receives the latch assembly. The latch assembly comprises at least one mounting member supporting the first arm of the hinge plate on the lid via at least one bracket and at least one adjustable locking member. The at least one adjustable locking member includes a first end mounted to the second arm of the hinge plate and a second end engageable to a panel of the casing, such that a gap persists between a lip of the panel and the second end. At least one slot is adapted to be selectively aligned with at least one aperture of the at least one mounting member for facilitating adjustment of the gap between the second end of the at least one locking member and the lip of the panel, corresponding to dimensions of the panel. The at least one adjustable locking member is operable between a locking position and an unlocking position corresponding to an inclination of the casing. In the locking position, the at least one adjustable locking member engages the lip of the panel for locking the lid in the closed position when the casing is in a vertical position about a horizontal axis. In the unlocking position, the at least one adjustable locking member disengages from the lip of the panel for unlocking the lid to the open position, when the casing is in a tilted position towards opening of the lid, by the angle (β) ranging from about 0 degrees to about 90 degrees, about the horizontal axis.

### BRIEF DESCRIPTION OF THE ACCOMPANYING DRAWINGS

The disclosure itself, together with further features and advantages, will become apparent from consideration of the following detailed description, taken in conjunction with the accompanying drawings. One or more embodiments of the present disclosure are now described, by way of example only wherein like reference numerals represent like elements and in which:

FIG. 1A is a perspective view of a container, illustrating a latch assembly mounted on the container in accordance with an embodiment of the present disclosure;

FIG. 1B is a top view of the container of FIG. 1A, illustrating at least one mounting member of the latch assembly secured on the container, in accordance with an embodiment of the present disclosure;

FIG. 2A is a perspective view of the latch assembly, in accordance with an embodiment of the present disclosure;

FIG. 2B is a schematic view of the latch assembly, illustrating adjustment of a locking member of the latch assembly, in accordance with an embodiment of the present disclosure;

FIG. 2C is a schematic view of the latch assembly, illustrating adjustment of the locking member of the latch assembly, in accordance with another embodiment of the present disclosure;

FIG. 3 is a perspective view of a garbage bin, illustrating a latch assembly mounted on the garbage bin, in accordance with an embodiment of the present disclosure;

FIG. 4A is a perspective view of the container in a first inclined position, illustrating a locked position of the latch assembly to maintain a closed position of a lid, in accordance with an embodiment of the present disclosure;

FIG. 4B is a perspective view of the container in a second inclined position, illustrating an unlocked position of the latch assembly to maintain an open condition of the lid, in accordance with an embodiment of present disclosure; and

FIG. 4C is a perspective view of the container in a first inclined position, illustrating the operation of the latch assembly in the event of a wind flow, in accordance with an embodiment of present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

Embodiments of the present disclosure provide a latch assembly for a container. The latch assembly is adapted to maintain a closed position and an open position of a lid of the container, corresponding to an inclination of the container. The latch assembly may thus facilitate operating the lid to the open position by inclining the container and thus mitigate the necessity for a vendor to actuate the lid. The latch assembly also ensures that the lid remains in the closed position when the container is in an upright position. Thus, embodiment of the present disclosure preclude the need for cumbersome coupling devices for locking the lid in the closed position.

The latch assembly includes at least one mounting member coupled to the container and at least one locking member pivotally mounted to the mounting member. The locking member is operable between a locking position and an unlocking position corresponding to the inclination of the container. The locking member is operated to the locking position, when the container is in a first inclined position about the horizontal axis i.e. a vertical position. Also, the locking member is operated to the unlocking position, when the container is in a second inclined position, for e.g. a tilted position. The container may be tilted about an angle (β) towards the lid opening, ranging from about 0 degree to about 90 degree from the horizontal axis. The locking member in the locking position is adapted to engage with a panel of the container so that the lid is secured in the closed position. The locking member in the unlocked position disengages from the panel, thereby permitting articulation of the lid to the open position from the closed position.

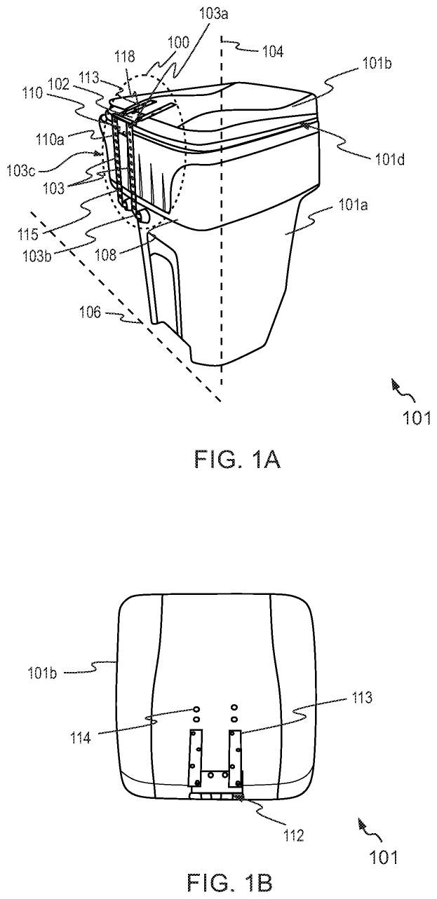

Various embodiments of the latching device are explained with reference to FIGS. 1 to 4A-4C.

FIG. 1 in one exemplary embodiment of the present disclosure illustrates a latch assembly 100 mounted on to a container 101. As depicted in the figure, the container 101 includes a casing 101a for storing a waste material and a lid 101b which is operable between an open position 101c and a closed position 101d, for enclosing the waste material.

The latch assembly 100 includes at least one mounting member 102 coupled to the container 101, to act as a foothold, and to provide stability required for operating the latch assembly 100 on the container 101. The latch assembly 100 also includes at least one locking member 103 having a first end 103a pivotally mounted to the mounting member 102 and a second end 103b adapted to engage with a panel 108 of the container 101. The locking member 103 is adapted to operate between a locking position 103c and an unlocking position 103d corresponding to the inclination of the container 101. In an embodiment, the locking member 103 operates between the locking position 103c and the unlocking position 103d, due to the gravitational force that is transferred to the locking member 103, when the container 101 is subjected to inclination. The locking member 103 in the locking position 103c is adapted to engage with the panel 108 of the container 101 so that the lid 101b is secured in the closed position 101d. The locking member 103 in the unlocking position 103d is adapted to disengage from the panel 108 so that the lid 101b can be articulated to the open position 101c.

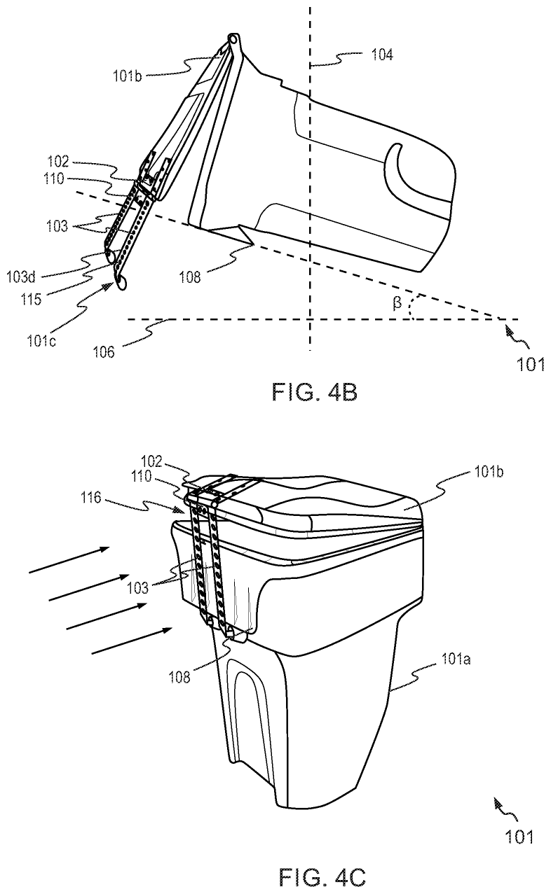

Further, the locking member 103 is operated to the locking position 103c when the container 101 is in a first inclined position 104. The first inclined position 104 may be a vertical position of the container 101 about a horizontal axis 106 (e.g. as shown in FIG. 4A). This configuration ensures that the lid 101b, when actuated to the closed position 101d, may enable the locking member 103 to be operated to the locking position 103c instantaneously. Hence, such configuration secures the lid 101b in the closed position 101d.

The locking member 103 is operated to the unlocking position 103d when the container 101 is in a second inclined position 105. The second inclined position 105 may be a tilted position of the container 101 towards an opening 107 of the lid 101b at the angle (β), with respect to the horizontal axis 106 (e.g., as shown in FIG. 4B). The angle (β) may be an angle ranging from about 0 degrees to about 90 degrees. This configuration ensures that, when the container 101 is tilted towards the opening 107 of the lid 101b, the locking member 103 automatically disengages thereby allowing the lid 101b to be articulated to the open position 101c from the closed position 101d. This mechanism thus mitigates the need for manual intervention for operating the lid 101b to the open position 101c from the closed position 101d.

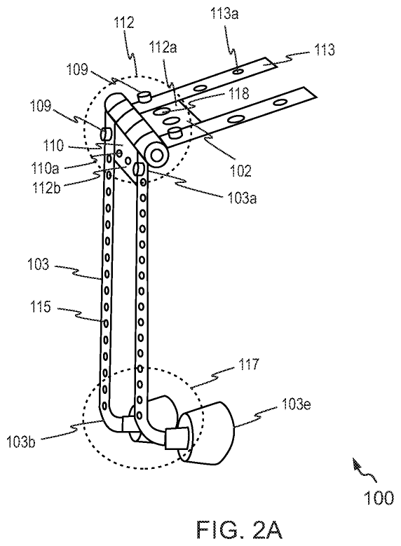

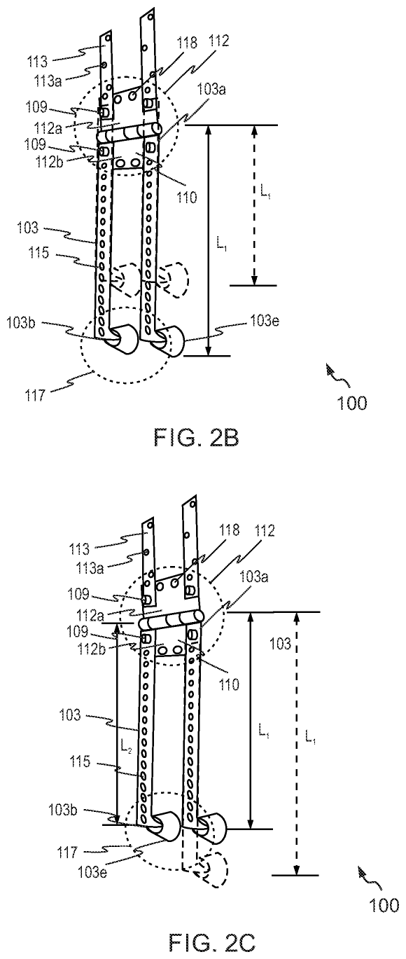

Referring to FIG. 2A in conjunction with FIG. 1A, the locking member 103 further includes a grommet 103e secured to the second end 103b, for engaging with the panel 108 of the container 101. The grommet 103e is adapted to provide necessary clamping force to lock the lid 101b in the closed position 101d, when the locking member 103 is in the locking position 103c. The grommet 103e may be defined or configured with a profile suitable for engaging with the panel 108 of the container 101. In an embodiment, the grommet 103e may be defined with a tapered profile, for engagement with the lip 108a of the panel 108. Also, the profile of the second end 103b of the locking member 103 may be shaped to enhance the effective engagement of the grommet 103e with the panel 108. The profile of the second end 103b of the locking member 103 may be selected from at least one of a curved profile, straight profile or any other profile which serves the purpose. In an embodiment, the second end 103b of the locking member 103 is configured with a bent profile, thereby shaping the locking member 103 to an L-shaped member.

In an embodiment, the grommet 103e may be made of materials such as but not limited to metallic materials and non-metallic materials as per design feasibility and requirement. In an exemplary embodiment, the grommet 103e is made of a rubber material, so that the rubber material may provide sufficient clamping force to the locking member 103 in the locking position 103c.

In another embodiment, the profile of the grommet 103e may be shaped such that, the grommet 103e may slide on a surface of the panel 108 prior to its coupling with the lip 108a. In other words, the grommet 103e may be configured with a profile which can slide on the surface of the panel 108, prior to its coupling with the lip 108a, during operation of the locking member 103 from the unlocking position 103d to the locking position 103c. This configuration facilitates a smooth transition of the locking member 103 from the unlocking position 103d to the locking position 103c.

Referring to FIG. 2B, the locking member 103 may include at least one slot 115 on its surface, for receiving at least one fastener 109. The fastener 109 is adapted to secure the locking member 103 with the mounting member 102 via at least one strut 110. The slot 115 are aligned with at least one aperture 110a provided on the strut 110, selectively so that a dimension L₁ of the locking member 103 corresponds to the dimensions L₂ of the panel 108. The dimensional adjustment is selected such that a gap 111 persists between a lip 108a of the panel 108 and the second end 103b, after engagement between the locking member 103 and the panel 108.

In an embodiment, the strut 110 may be a plate-like structure, which may be secured to the mounting member 102, and may act as a supporting structure for receiving the locking member 103. In an exemplary embodiment, the strut 110 may be a second arm 112b of a hinge plate 112 mounted to the container 101.

In an embodiment, the strut 110 may also act as a guide-way (not shown in FIGS.) so that the locking member 103 may slide over the strut 110 during dimensional adjustment. In another embodiment, the locking member 103 may also be configured as a telescopic member, so that dimension L₁ the locking member 103 may be adjusted as per requirement.

In an embodiment, the locking member 103 may be two locking members, which may be adapted to engage with the panel 108. In the event of use of multiple locking members, the dimensions of one of the locking members 103 may be adjusted corresponding to the dimensions of the panel 108 (e.g., as shown in FIG. 2C).

In an embodiment, the at least one mounting member 102 is fastened to the lid 101b of the container 101, particularly on an open end of the lid 101b of the container 101 (e.g., as shown in FIG. 1A).

In an embodiment, the shape of the mounting member 102 is selected from at least one of a rectangular shape, a circular shape, a square shape or any other shape as per design feasibility and requirement.

In an embodiment, the mounting member 102 is secured such that, the performance characteristics of the lid 101b are retained. In other words, the structural rigidity and the leak-proof closure characteristic of the lid 101b are retained, even after securing the mounting member 102.

In an embodiment, the mounting member 102 may be a first arm 112a of the hinge plate 112, fastened onto the lid 101b of the container 101.

In an embodiment, the mounting member 102 may be secured to the lid 101b by means such as, but not limited to, a fastening means, a snap-fit means or any other means, which serves the purpose.

In an embodiment, the mounting member 102 may be mounted onto the container 101 via one or more brackets 113. The brackets 113 are adapted to enhance the stability of the mounting member 102 on the container 101. In an exemplary embodiment, the brackets 113 are fastened to the lid 101b by the fastener 109. In another embodiment, the brackets 113 may be secured to the lid 101b by means such as but not limited to the fastening means, the snap-fit means or any other means, as per design feasibility and requirement.

In an embodiment, the one or more brackets 113 may be a plate-like structure, which shifts the attachment point of the mounting member 102 on the container 101, for enhancing the stability.

In another embodiment, each of the one or more brackets 113 includes at least one slit 113a which may enable a user to shift the attachment point of the mounting member 102 on the container 101. The slit 113a is adapted to align with at least one perforation 114 provided on the lid 101b (e.g., as shown in FIG. 1B) for fastening and, thereby shifting the attachment point of the mounting member 102.

In an embodiment, the lid 101b of the container 101 may be operated to the closed position 101d from the open position 101c, either manually by the user or by means of automation as per design feasibility and requirement.

In an embodiment, the container 101 may be inclined between the first inclined position 104 and the second inclined position 105 either manually or by means of automation as per design feasibility and requirement.

In an embodiment, the panel 108 may be a projection, a protrusion, a ridge, a protuberance or any other surface provided on the casing 101a of the container 101, which facilitates engagement with the locking member 103. In another embodiment, the panel 108 may be the casing 101a of the container 101 and may include a cutout, or a slit or any other surface projection which facilitates engagement with the locking member 103.

In an embodiment, the container 101 is selected from groups such as but not limited to a vessel, a receptacle, a canister or any other storage means, which facilitates storage of at least one object. In an exemplary embodiment, the container 101 is a garbage container.

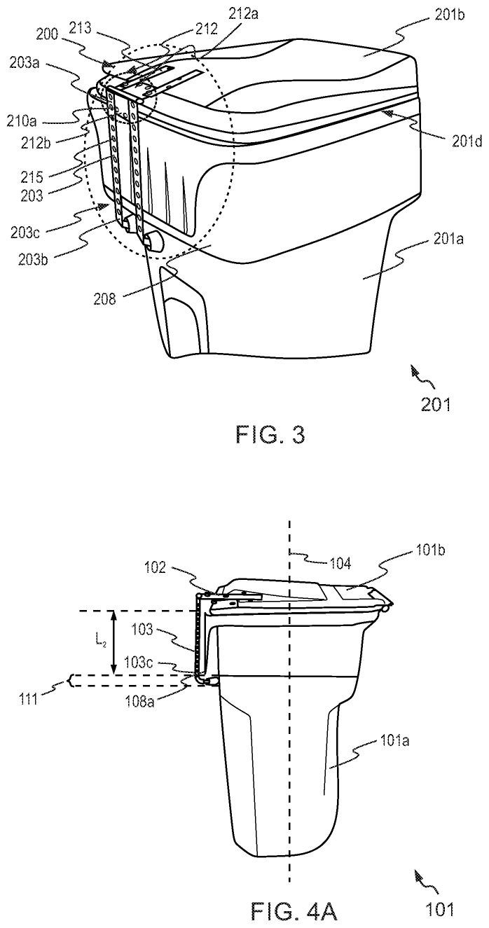

FIG. 3, in another exemplary embodiment of the present disclosure, illustrates a latch assembly 200 mounted onto a garbage bin 201. The garbage bin 201 includes a casing 201a for storing garbage and a lid 201b, pivotally mounted on the casing 201a. The lid 201b is operable between an open position and a closed position 201d.

The garbage bin 201 includes the hinge plate 212 mounted on the lid 201b and includes a first arm 212a and a second arm 212b. The hinge plate 212 is adapted to receive and operate the latch assembly 200. The latch assembly 200 includes at least one bracket 213 with one end fastened to a mounting member 202 and other end fastened to the lid 201b. The bracket 213 acts as a supporting member to provide stability to the latch assembly 200 during operation. Further, at least one adjustable locking member 203 is provided, wherein a first end 203a of the adjustable locking member 203 is mounted to the second arm 212b of the hinge plate 212 and a second end 203b of the adjustable locking member 203 is adapted to engage with a panel 208 of the casing 201a. The adjustable locking member 203 is adapted to be operable between a locking position 203c and an unlocking position corresponding to the inclination of the casing 201a.

The adjustable locking member 203 includes at least one slot 215 which aligns with at least one aperture 210a on the second arm 212b, and thereafter the adjustable locking member 203 is fastened. The adjustable locking member 203, based on the position of the slot 215 is adapted to function similar to the adjustable locking member 203 of the latch assembly 200, for adjusting the length corresponding to the dimensions of the panel 208.

In the locking position 203c, the adjustable locking member 203 engages the lip 208a of the panel 208 for locking the lid 201b in the closed position 201d, when the casing 201a is in a vertical position about a horizontal axis. Thus, as soon as the lid 201b is shut to the closed position 201d, the adjustable locking member 203 under the action of gravity instantaneously drops down to the vertical position and engage with the lip of the panel. Hence securing the lid 201b with the casing 201a of the container 101.

In the unlocking position 203d, the adjustable locking member 203 disengages from the lip of the panel for unlocking the lid 201b to the open position, when the casing 201a is in a tilted position towards opening of the lid 201b, by the angle (β) ranging from about 0 degrees to about 90 degrees, about the horizontal axis. Due to the tilted position and the resulting gravitational force, the adjustable locking member 203 disengages from the lip 201b and articulates away from the lip 201b, thereby allowing actuation of the lid 201b from the closed position 201d to the open position. Hence, in the open position, the garbage can be accessed and dumped as per requirement.

Further, as the aforementioned latch assembly 200 is an embodiment of the latch assembly 100, the embodiments described from the latch assembly 100 collectively apply for the latch assembly 200.

In an embodiment, the latch assembly 200 may be configured to the hinge plate 112 such that the first arm 112a of the hinge plate 112 may act as the mounting member 102 and the second arm 112b of the hinge plate 112 may act as the securing member for engaging with the panel 108.

FIGS. 4A and 4B, in one exemplary embodiment of the present disclosure, illustrate operational views of the latch assembly 100 of the container 101.

Referring to FIG. 4A, a user or a vendor, upon dumping objects into the container 101, articulates the lid 101b to the closed position 101d, to enclose the objects within the container 101. In this scenario, as soon as the vendor shuts the lid 101b to the closed position 101d, the locking member 103 under the action of gravity instantaneously drops down vertically to engage with the lip 108a of the panel, thereby securing the lid 101b with the casing 101a of the container 101.

Referring to FIG. 4B, the vendor in need of accessing the contents of the container 101, tilts the container 101 from the vertical position 104 to the second inclined position 105. Due to the tilted position and the resulting gravitational force, the locking member 103 disengages from the lip 108a and articulates away from the lip 108a, thereby allowing actuation of the container 101 from the closed position 101d to the open position 101c. In this scenario, the vendor can access the contents as per his requirement.

In an embodiment, in the event of transmission of force on the lid 101b say for example, due to wind blowing, the lid 101b being light in weight, may try to lift itself to the open position 101c. However, due to the configuration of the gap 111, the grommet 103e engages with the lip 108a, thereby allowing a minor opening 116 of the lid 101b (as shown in FIG. 4C). In an embodiment, the gap 111 between the lip 108a of the panel 108 and the grommet 103e, defines extent of the minor opening 116 of the lid 101b in the locking position 103c. In other words, the minor opening 116 of the lid 101b is dependent on the gap 111 between the lip 108a of the panel and the grommet 103e. Thus, reducing the gap 111 reduces the minor opening 116. However, reduction of the gap 111 must be considered, based on the articulation that is required during tilting of the container 101. In an embodiment, if the gap 111 is negligible, higher tilting angles of the container 101 may be required for unlocking the lid 101b.

In an embodiment, if the locking member 103 is already in the locking position 103c prior to the shut-off of the lid 101b, the second end 103b of the locking member 103 may slide over the panel 108 prior to engagement with the lip 108a.

In an embodiment, for optimal engagement of the locking member 103 with the panel 108, the second end 103b of the locking member 103 may need to be completely engaged with the lip 108a (e.g., as shown in FIG. 4A). In other words, the curved portion 117 (e.g., as shown in FIG. 2A) of the second end 103b may completely engage with the lip 108a, for optimal engagement. At the same time, the length of the mounting member 102 protruding away from the lid 101b may need to be set at an optimum distance for optimal engagement of the second end 103b.

In another embodiment, the curved portion 117 of the second end 103b ensures that the lid 101b is in the closed position 101d until the vendor tilts the container 101 to a predetermined angle. In other words, the curved portion 117 prevents opening of the lid 101b, for minor tilt angles of the container 101, thereby maintaining the locking position 103c of the locking member 103. In an embodiment, the minor tilt angles may range from about 1 degree to about 5 degrees.

In another embodiment, the curved portion 117 of the locking member 103 may be defined with an included angle for optimal engagement with the lip 108a (not shown in FIGS.). The included angle may prevent unlocking of the lid 101b due to unintended movement of the container 101, while also not hindering engagement with the lip 108a during operation of the locking member 103 from the unlocking position 103d to the locking position 103c.

In an embodiment, each of the at least one locking member 103 may be made of materials selected from at least one of a metallic material and a non-metallic material. In an exemplary embodiment, the at least one locking member 103 may be made of aluminum. In another embodiment, each of the at least one locking member 103 may be made of different materials.

In an embodiment, a shape of the locking member 103 may be selected from a group such as but not limited to rectangular shape, a circular shape, a square shape or any other geometric shape, as per design feasibility and requirement.

In an embodiment, each of the at least one mounting member 102 may be made of materials selected from at least one of the metallic material and the non-metallic material. In an exemplary embodiment, the mounting member 102 may be made of aluminum. In another embodiment, the mounting member 102 may be made of different materials.

In an embodiment, a shape of the mounting member 102 may be selected from a group such as but not limited to the rectangular shape, the circular shape, the square shape or any other geometric shape, as per design feasibility and requirement.

In an embodiment, the slot 115 defined on the locking member 103 is adapted to adjust length of the locking member 103, as per a distance of the lip 108a from the mounting point of the latch assembly 100.

In an embodiment, the at least one slit 113a defined on the mounting member 102 is adapted to adjust length of the mounting member 102 as per stability requirement of the latch assembly 100.

In an embodiment, the fastener 109 on the locking member 103 and the mounting member 102 is selected from group such as but not limited to a screw member, a pin member or any other member as per design feasibility and requirement.

In an embodiment, the mounting member 102 may be mounted on the casing 101a of the container 101, and the locking member 103, may be adapted to engage the lid 101b for locking the lid 101b in the closed position 101d.

### ADVANTAGES

In an embodiment, the present disclosure provides a latch assembly, which is adapted to prevent automatic unlatching of a lid of the container.

In an embodiment, the present disclosure provides a latch assembly, which operates between a locking position and an unlocking position, corresponding to the inclination of the container.

In an embodiment, the present disclosure provides a latch assembly, which mitigates the need for human intervention for unlocking the lid of the container.

In an embodiment, the present disclosure provides a latch assembly which is modular, simple in design, modular and scalable corresponding to the configuration of the container.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims.

What is claimed is:

1. A latch assembly for a container, comprising:
at least one mounting member coupled to the container, the container comprising a lid operable between an open position and a closed position; and
at least one locking member pivotally mounted to the at least one mounting member, the at least one locking member operable between a locking position and an unlocking position, corresponding to an inclination of the container, wherein,
in the locking position, the at least one locking member engages a panel of the container for locking the lid in the closed position, when the container is in a first inclined position, and
in the unlocking position, the at least one locking member disengages from the panel for unlocking the lid to the open position, when the container is in a second inclined position.

2. The latch assembly as claimed in claim 1, wherein the at least one mounting member is fastened to a lid of the container.

3. The latch assembly as claimed in claim 1, wherein the first inclined position is a vertical position of the container about a horizontal axis.

4. The latch assembly as claimed in claim 1, wherein the second inclined position is a tilted position of the container towards opening of the lid, by an angle (β) ranging from about 0 degrees to about 90 degrees, about the horizontal axis.

5. The latch assembly as claimed in claim 1, wherein the at least one locking member engages with a lip of the panel, for locking the lid in the closed position.

6. The latch assembly as claimed in claim 1, wherein the at least one locking member includes a first end fastened to the at least one mounting member and a second end including a grommet adapted to engage with the panel for locking the lid in the closed position.

7. The latch assembly as claimed in claim 6, wherein a gap persists between the second end of the at least one locking member and the lip such that the at least one locking member is adapted to disengage from the lip, when the container is in the second inclined position.

8. The latch assembly as claimed in claim 7, wherein each of the at least one locking member comprises at least one slot, wherein each of the at least one slot is selectively aligned with at least one aperture of each of the at least one mounting member to facilitate adjustment of the gap between the lip of the panel and the second end of the at least one locking member.

9. The latch assembly as claimed in claim 1, wherein the at least one locking member is adjustable corresponding to dimensions of the panel.

10. The latch assembly as claimed in claim 1, wherein the at least one mounting member is fastened to a barrel of the container.

11. The latch assembly as claimed in claim 1 comprises at least one bracket having one end secured to the each of the at least one mounting member and the other end mounted to the lid of the container, for supporting the at least one mounting member on the lid.

12. A container, comprising:
a casing for storing at least one object;
a lid pivotally mounted on the casing for containing the at least one object, the lid operable between an open position and a closed position; and
a latch assembly, comprising:
at least one mounting member coupled to the lid; and
at least one locking member pivotally mounted to the at least one mounting member, the at least one locking member operable between a locking position and an unlocking position, corresponding to an inclination of the casing, wherein,
in the locking position, the at least one locking member engages a panel of the casing for locking the lid in the closed position, when the casing is in a first inclined position, and
in the unlocking position, the at least one locking member disengages from the panel for unlocking the lid to the open position, when the casing is in a second inclined position.

13. The container as claimed in claim 12, wherein the first inclined position is a vertical position of the casing about a horizontal axis.

14. The container as claimed in claim 12, wherein the second inclined position is a tilted position of the casing towards opening of the lid, by an angle (β) ranging from about 0 degrees to about 90 degrees, about the horizontal axis.

15. The container as claimed in claim 12, wherein the at least one locking member engages with a lip of the panel for locking the lid in the closed position.

16. The container as claimed in claim 12, wherein the at least one locking member includes a first end fastened to the at least one mounting member and a second end including a grommet adapted to engage with the panel for locking the lid in the closed position.

17. The latch assembly as claimed in claim 16, wherein a gap persists between the second end of the at least one locking member and the lip such that the at least one locking member is adapted to disengage from the lip, when the container is in the second inclined position.

18. The container as claimed in claim 17, wherein each of the at least one locking member comprises at least one slot, wherein each of the at least one slot is selectively aligned with at least one aperture in the at least one mounting member for adjustment of the gap between the lip of the panel and the second end of the at least one locking member.

19. The latch assembly as claimed in claim 1, further comprising at least one bracket, wherein one end of the at least one bracket is secured to each of the at least one mounting member and other end of the at least one bracket is mounted to the lid of the container for supporting the at least one mounting member on the lid.

20. A garbage container, comprising:
a casing for storing garbage;
a lid pivotally mounted on the casing, the lid operable between an open position and a closed position;
a hinge plate including a first arm and a second arm, the hinge plate mounted on the lid via the first arm;
a latch assembly, comprising:
at least one bracket mounted on the lid for supporting the first arm of the hinge plate; and
at least one adjustable locking member comprising:
a first end mounted to the second arm of the hinge plate,
a second end engageable to a panel of the casing such that a gap persists between a lip of the panel and the second end, and
at least one slot adapted to be selectively aligned with at least one aperture of the second arm for adjustment of the gap between the second end of the locking member and the lip of the panel, corresponding to dimensions of the panel,
the at least one adjustable locking member operable between a locking position and an unlocking position corresponding to an inclination of the casing, wherein,
in the locking position, the at least one adjustable locking member engages the lip of the panel for locking the lid in the closed position, when the casing is in a vertical position about a horizontal axis, and
in the unlocking position, the at least one adjustable locking member disengages from the lip of the panel for unlocking the lid to the open position, when the casing is in a tilted position towards opening of the lid, by an angle (β) ranging from about 0 degrees to about 90 degrees, about the horizontal axis.
